(19) United States
(12) Patent Application Publication
(10) Pub. No.: US 2023/0153861 A1
(43) Pub. Date: May 18, 2023

(54) MESSAGING DISPLAY SYSTEM AND METHOD

(71) Applicant: Joram Mogaka, West Bloomfield, MI (US)

(72) Inventor: Joram Mogaka, West Bloomfield, MI (US)

(21) Appl. No.: 17/524,792

(22) Filed: Nov. 12, 2021

(51) Int. Cl. G06Q 30/02; H04L 12/18; H04W 4/23

(52) U.S. Cl. CPC G06Q 30/0265; H04L 12/189; H04W 4/23

(57) ABSTRACT

A messaging display system and method is disclosed to allow end users to display messages on in-vehicle mountable displays that frequent an area of interest. The end user selects an area of interest using a map. A server identifies the in-vehicle mounted displays that frequent the area of interest. The end user selects the desired in-vehicle mounted displays on which to broadcast their message. The end user can select based on the average time an in-vehicle mounted display is within the area of interest on a given day; on the average distance an in-vehicle mounted display travels through the area of interest on a given day; or on a weighted combination of both time and distance.

### FIELD OF INVENTION

The present invention relates to the classification for systems for selective content distribution; and to one or more sub-classifications for scheduling content for creating a personalized stream. The present invention also relates to the classification for data processing methods specifically adapted for commercial purposes; and to one or more sub-classifications related to commerce and marketing. Specifically, the present invention is a message display system and method that allows for on-demand messaging to be displayed on vehicles in a user-defined local area.

### BACKGROUND OF INVENTION

As society continues to be more immersed in social media, it has become one of the most, if not the most important form of communication. Its applications have been very wide and to a very large extent, very successful. From personal communication to advertising, to business and all other spheres of life, social media has redefined the way we interact and indeed live our lives.

However, while social media has largely taken place in the spheres of the internet, cell phones and other interpersonal domains, it has not yet been applied to direct location-based messaging. This domain is still occupied primarily by large media organizations, advertising agencies, and government and civil authorities. As a result, large sectors of business are still reserved for large corporations, who still dominate dissemination of information such as news, advertising, and public broadcasting. The market is seeking a way to democratize the dissemination of location-based messages. By location-based messages, this application means messages that are broadcast to a certain geography through means other than a cellphone or computer.

For example, one of the ubiquitous forms of location-based messaging is the billboard. Billboards are controlled by large media companies. Advertising on them is still prohibitively expensive. Moreover, the messaging is stagnant. Billboards typically remain in situ for at least one month. Individuals and small businesses are left with trying to break into markets with largely ineffective methods such as portable visual displays, stickers, storefront signage, and Internet advertising. If they desire to advertise in a more effective manner, they are forced to invest large sums of money with the advertising companies to use media such as billboards.

What the market needs is the democratization of location-based advertising, meaning advertising performed at a specific physical location. What the market needs is a system and method that will provide moving displays on which an end user can broadcast a message, such as an advertisement, within a certain geographic region.

### SUMMARY OF THE INVENTION

This summary is intended to disclose the present invention, a message display system and method that allows for on-demand messaging to be displayed on vehicles in a user-defined local area. The embodiment and description are used to illustrate the invention and its utility and are not intended to limit the invention or its use. The following presents a simplified summary of the primary embodiment of the invention to provide a basic understanding of the invention. Additional concepts that can be added or varied with the primary embodiment are also disclosed. The present invention is novel with respect to the prior art, and can be distinguished from the prior art.

In general, the present invention, a message display system and method that allows for on-demand messaging on vehicles in user defined local area, provides targeted on-vehicle messaging in a known local area. The system comprises a plurality of in-vehicle mountable displays, a plurality of end-user electronic devices, a communications network, and a server connected with a database. The in-vehicle mountable displays are comprised of a flexible screen, a flexible border, a USB port, a communications chipset, a memory, a graphics driver, and a global positioning system chipset. The end-user electronic device has a memory element, a processor, and a display. A computer-readable instruction set called a user application is stored on the memory element of the end-user electronic device. A computer-readable instruction set called a display application is stored on the memory of the in-vehicle mountable display.

The server intermediates the method of the present invention, by executing a computer-readable instruction set that interoperates with the display application and the user application. The end-user creates a message using the user application on their cellphone or other end-user electronic device. The end-user can select message options, such as animation, text wrapping, color, and added graphics such as a picture. The end user identifies an area of interest to the method, by setting the border around the end user's preferred area of interest on a map. This information is communicated by the communication chip set of the cellphone to the server using the communication network. The server communicates the available vehicles to the user, who reviews them. The end user is able to set a criterion to sort the vehicles by the average time (“Time”) the vehicle is within the area of interest during an average day; or by the average distance (“Distance”) traveled by the vehicle within the area of interest during an average day. If the end user chooses Distance, he or she selects the appropriate vehicles. If the end user chooses Time, he or she selects the appropriate vehicles. The end user then selects the duration and repetition of their intended message. This information is communicated to the server which supplies pricing information. The end user may say the price is okay or the price is not okay. If the price is okay, the advertising campaign is executed and the end user is charged. If the price is not okay, the end user may exit or iterate to select new parameters.

The display of the flexible screen has three mark-off areas that can be reserved for additional information such as battery life, signal strength, and display ID. In one embodiment, the flexible border can be covered with a pressure sensitive adhesive (“PSA”), so that the in-vehicle mountable display can be directly mounted to the rear window of a vehicle. Alternately, the in-vehicle mountable display can be mounted with suction cups.

The in-vehicle mountable display is attached to the rear window of a vehicle. The message displayed on the flexible screen is easily visible to those outside the vehicle. An end-user can put an in-vehicle mountable display in their own vehicle in order to use the in-vehicle mountable display as an electronic messaging board—the equivalent of a new-age bumper sticker. An end-user can also access other vehicles that have made their in-vehicle mountable displays available for advertising or messaging.

In one embodiment, the end-user electronic device has a touch screen that acts as both a display and an input device. The touch screen shows a graphic user interface (“GUI”). The GUI displays a proposed message. The proposed message is transmitted to one of a plurality of in-vehicle mountable displays, where the message is displayed on the flexible screen. The GUI includes options for the display of the message, including things like animation, text wrapping, color, and added graphics such as a picture.

After an end-user has selected a message, they choose an area of interest. The end user is presented with a map. The end user sets an area of interest by placing a border around it. The area of interest is where the end-user wants to display their message. The area of interest has a plurality of roads. The end-user is presented with the map through a menu on the GUI. The end-user is able to see a plurality of vehicles that are recurrently in the area of interest. The end user is able to access graphic information through the GUI showing the daily average amount of time (“Time”) and the daily average mileage (“Distance”) for each of a plurality of vehicles that are recurrently in the area of interest.

### BRIEF DESCRIPTION OF THE DRAWINGS

The present invention is illustrated with 8 drawings on 9 sheets. FIG. 1A is a front view of a flexible display screen with a flexible border. FIG. 1B is a perspective side view showing the curvature of the display screen. FIG. 1C is a top perspective view showing the curvature of the display screen and the electronics associated with the display screen.

FIG. 2 is a perspective method of a display screen with four suction cups with which to mount the display screen to a vehicle rear window.

FIG. 3 is rear view of a vehicle with the display screen mounted in the rear window.

FIG. 4 is a combined view showing an end-user electronic device communicating with the display screen.

FIG. 5A is a diagram showing an area of interest. FIG. 5B is a chart of average time within the area of interest for a selection of vehicles. FIG. 5C is a charge of average distance driven within the area of interest for a selection of vehicles.

FIG. 6 shows a communications configuration to enable the present invention.

FIG. 7 is a system chart of the present invention.

FIG. 8 is a flow chart of the primary method of the present invention.

### DETAILED DESCRIPTION OF THE DRAWINGS

The following descriptions are not meant to limit the invention, but rather to add to the summary of invention, and illustrate the present invention, a message display system and method that allows for on-demand messaging on vehicles in a user-defined local area. The present invention is illustrated with a variety of drawings showing the primary embodiment of the present invention, with examples presented of the various form-factors that the present invention can take.

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

FIG. 1A shows an in-vehicle mountable display 1. The in-vehicle mountable display 1 has a flexible screen 2 and a flexible border 3, and a USB port 4. In one embodiment, the flexible screen 2 is fabricated from an organic liquid crystal display (“OLCD”). A message 6 can be displayed on the flexible screen. The display of the flexible screen 2 have three mark-off areas 7, 8, 9, that can be reserved for additional information such as battery life 7, signal strength 8, and display ID 9. The as battery life 7 and signal strength 8 mark-offs can be turned on by an user device, such as the cellphone belonging to the vehicle owner. The display ID 9 can be temporarily turned on by an end-user electronic device 200. In one embodiment, the flexible border 3 can be covered with a PSA, so that the in-vehicle mountable display 1 can be directly mounted to the rear window of a vehicle.

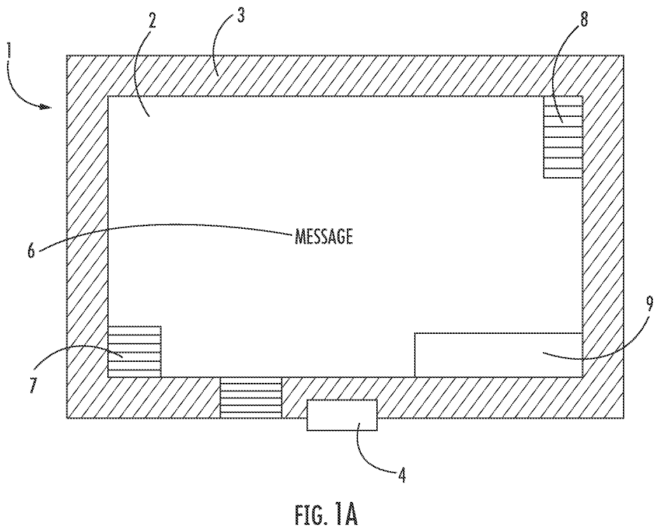

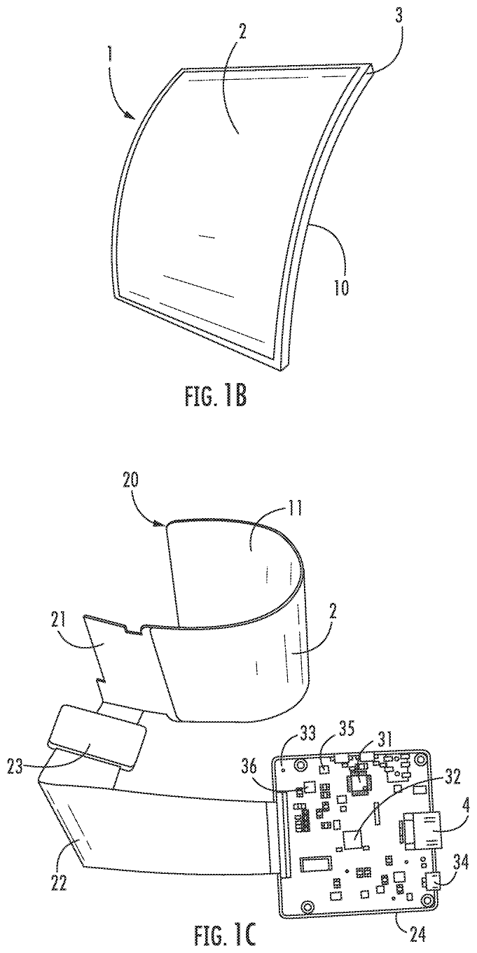

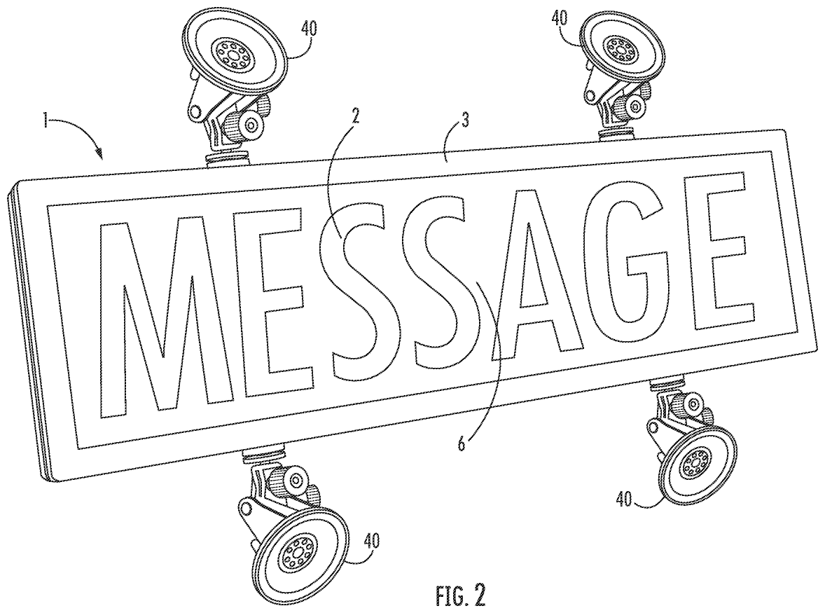

FIG. 2 shows an alternative embodiment for mounting the in-vehicle mountable display 1. The mounting would be effect with the use of a plurality of suction cups 40. In this embodiment, four suction cups 40 are used. In FIG. 2, the in-vehicle mountable display 1 is visible, along with its flexible screen 2, the flexible border 3, and a message 6 displayed on the flexible screen 2

FIG. 1B is a perspective side view showing the in-vehicle mountable display 1. In this view, the flexible screen 2 and flexible border 3 are visible, as is the curvature 10 of the display.

FIG. 1C shows a combined view of the flexible display 2 and its associated electronics. In this view, the flexible display 2 has a front 2 and a back 11. The front 2 of the flexible display 2 is capable of displaying a message 6. The flexible display 2 has a definable edge 22. At one end of the flexible display 2 is a header 21 which allows the flexible display 2 to be attached to its associated electronics. In this embodiment, the header 21 is attached to a graphics driver board 23. The graphics driver board 23 is connected to a main board 24 with a flex cable 22. The main board 24 has a plurality of communication ports 4, 34. In this embodiment, the communications ports 4, 34, are a lightning port 34 and a USB port 4. Of course, additional communications ports 4, 34 are possible and the precise identity of the communications ports 4, 34 are not a limitation of this invention. The main board 24 is a PCB with a top side 33. The electrical components are mounted on the top side 33. There is a global positioning system (“GPS”) chip 32, a communications chip 35, and a memory 31. The remainder of the components 36 are passives, op amps, and other electronic components. The flexible display 2, header 21, driver board 23, main board 24, and flex cable 22 can be housed in a minimalist flexible in-vehicle mountable display 1 with a flexible border 3.

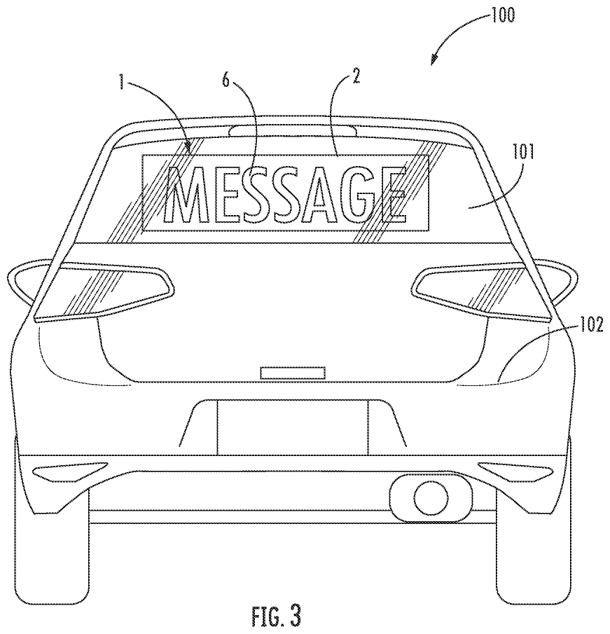

In FIG. 3, the in-vehicle mountable display 1 is attached to the rear window 101, of a car 100. The message 6 displayed on the flexible screen 2 is easily visible to those outside the car 100. An end-user can put an in-vehicle mountable display 1 in their own vehicle 100 in order to use the in-vehicle mountable display 1 as an electronic messaging board—the equivalent of a new-age bumper sticker. An end-user can also access other vehicles 100 that have made their in-vehicle mountable displays 1 available for advertising or messaging 6.

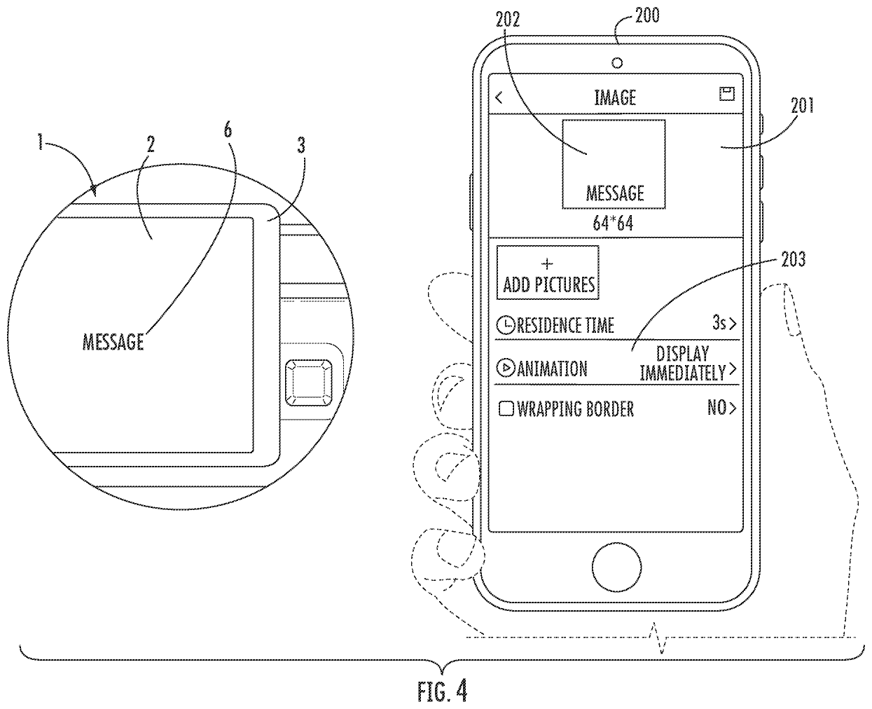

FIG. 4 shows the in-vehicle mountable display 1 being used in conjunction with an end-user electronic device 200. In this embodiment, the end-user electronic device 200 is a cellphone 200. The cellphone 200 has a touch screen 201 that acts as both a display and an input device 201. The touch screen 201 shows a graphic user interface (“GUI”) 201. The GUI 201 displays a proposed message 202. The proposed message 202 is transmitted to one of a plurality of in-vehicle mountable displays 1, where the message 6 is displayed on the flexible screen 2. The GUI 201 includes options for the display of the message 203, including things animation, text wrapping, color, and added graphics such as a picture.

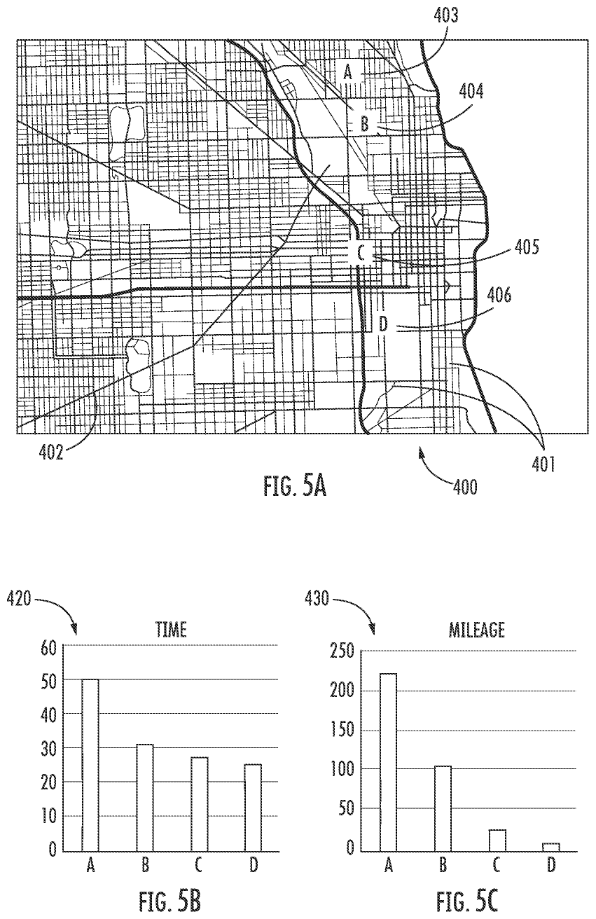

FIG. 5A shows map. The map's outer perimeter is an end-user defined border 400 that sets the boundary for the end-user's area of interest 402. The area of interest 402 is where the end-user wants to display their message 6. The area of interest 402 has a plurality of roads 401. The end-user is presented with the map through a menu on the GUI 201. The end-user is able to see a plurality of vehicles A (403), B (404), C (405), D (406) that are in the area of interest 402.

In FIG. 5B and 5C, the end user is able to access graphic information through the GUI showing the daily average amount of time 420 and the daily average mileage 430 for each of the four vehicles A (403), B (404), C (405), D (406) that are in the area of interest 402.

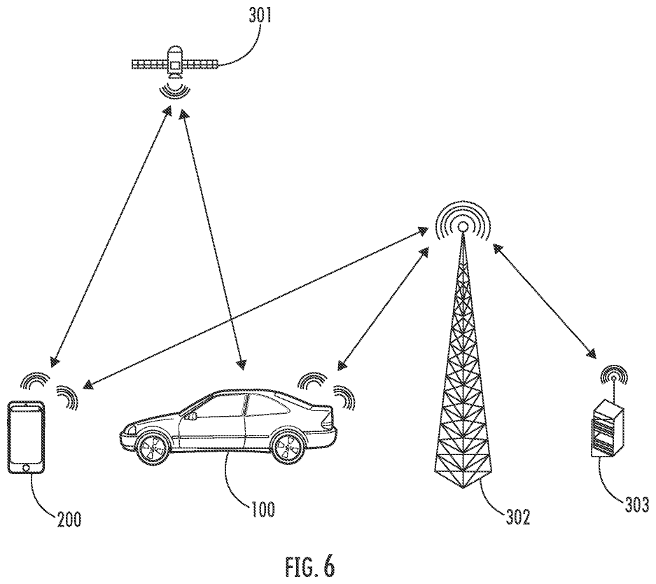

FIG. 6 shows an embodiment of a communication configuration for the present invention. A plurality of end-user electronic devices (cellphones) 200 are able to communicate via either a satellite network 301 or a cellular network 302. A plurality of vehicles 100 containing in-vehicle mountable displays 1 are able to communicate via either a satellite network 301 or a cellular network 302. The end user makes a request to display a user-defined message using the GUI 201 on the cellphone 100 which is transmitted to a server 303. The end user sets an area of interest 402. The server 303 has access to data showing information about available vehicles A (403), B (404), C (405), D (406), in the area of interest 402, on which messages 6 can be shown. Available vehicles A (403), B (404), C (405), D (406) are a sub-set of the plurality of vehicles 100. Location-based data is recorded from each of a plurality of vehicles 100 by recording their GPS coordinates versus using a GPS chipset 32 contained in the in-vehicle mountable display 1.

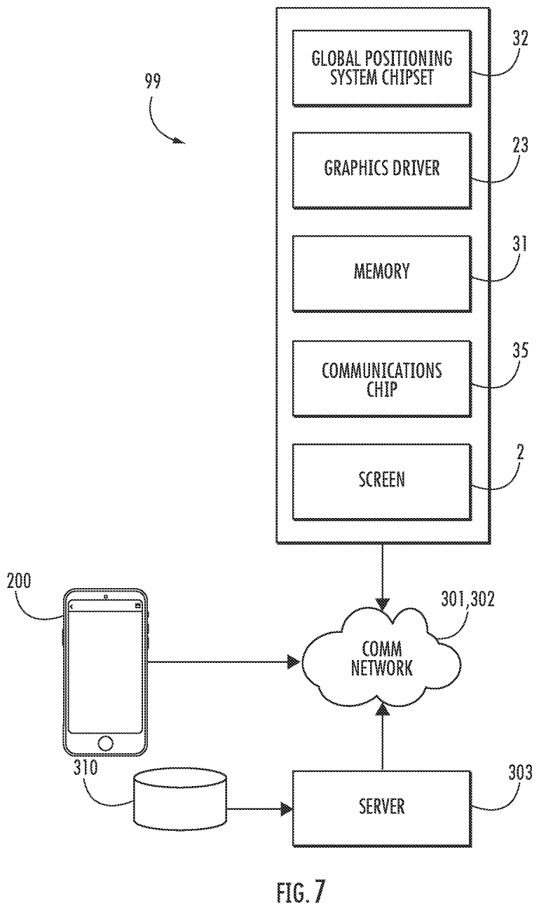

FIG. 7 shows the system of the current invention. The system comprises a plurality of in-vehicle mountable displays, a plurality of end-user electronic devices 200, a communications network 301, 302, and a server 303 connected with a database 310. The in-vehicle mountable displays 1 are comprised of a screen 2, a communications chipset 35, a memory 31, a graphics driver 23, and a global positioning system chipset 32. The end-user electronic device 200 has a memory element, a processor, and a display. A computer-readable instruction set called a user application is stored on the memory element of the end-user electronic device 200. A computer-readable instruction set called a display application is stored on the memory 31 of the in-vehicle mountable display 1

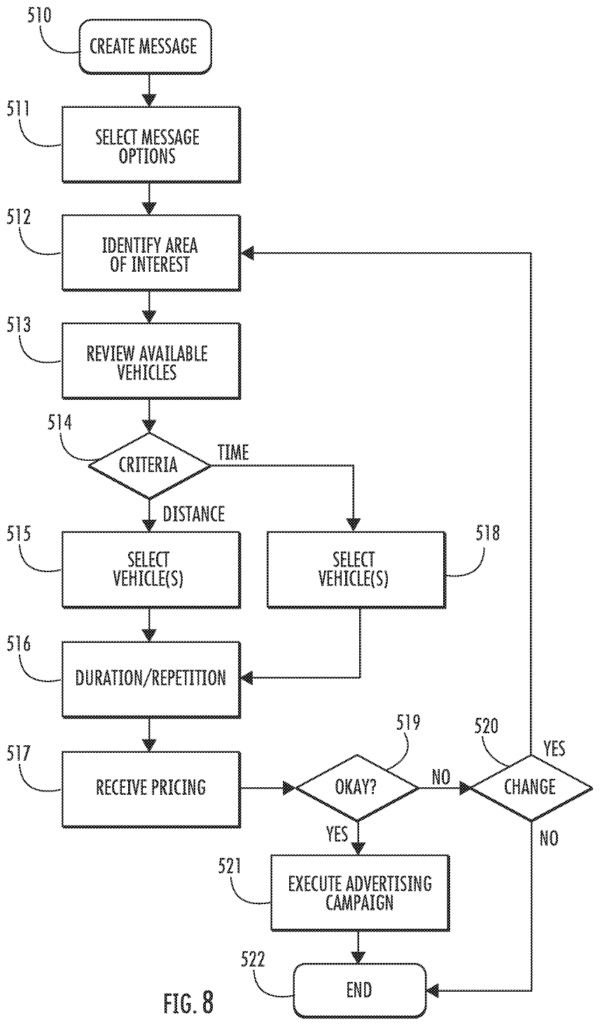

The server 303 intermediates the method of the present invention, by executing a computer-readable instruction set that interoperates with the display application and the user application. FIG. 8 shows the method. The end-user creates a message 510 using the user application on their cellphone 200, which initiates a session with the server 303. The end-user can select message options 511, such as animation, text wrapping, color, and added graphics such as a picture. The end user identifies an area of interest 512 to the method, by using a map and setting the border 400 around the end user's preferred area of interest 402. This information is communicated by the communication chip set 35 of the cellphone 200 to the server 303 using the communication network 301, 302. The server 303 communicates the available vehicles to the user, who reviews them 513. The end user is able to set a criterion 514 to sort the vehicles by the average time (“Time”) the vehicle is within the area of interest 402 during an average day; or by the average distance (“Distance”) traveled by the vehicle within the area of interest 402 during an average day. A weighted combination of Time and Distance can also be specified. If the end user chooses Distance, he or she selects the appropriate vehicles 515. If the end user chooses Time, he or she selects the appropriate vehicles. The end user then selects the duration and repetition 516 of their intended message 6. This information is communicated to the server 303 which supplies pricing information 517. The end user may say the price is okay 519 or the price is not okay 519. If the price is okay, the advertising campaign is executed 521 and the end user is charged. If the price is not okay, the end user may exit 522 or iterate 520 to select new parameters.

We claim:

1. A messaging display system comprising
a first plurality of in-vehicle mounted displays;
a second plurality of end-user electronic devices;
a communications network, and
a server connected with a database;
wherein each of the in-vehicle mounted displays are comprised of a flexible screen, a communications chipset, a memory chip, a graphics driver, and a global positioning system chipset;
wherein each end-user electronic device has a memory element, a processor, and a display; and
wherein an end user can target a message to be broadcast by one or more of the first plurality of in-vehicle mounted displays by using their end-user electronic device to define an area of interest, identify the vehicles that frequent the area of interest, and select one or more appropriate vehicle based off of a user selected criterion.

2. The messaging display system of claim 1, wherein the user selected criterion is the daily average amount of time that an in-vehicle mounted display spends within the area of interest.

3. The messaging display system of claim 1, wherein the user selected criterion is the daily average distance traveled within the area of interest by an in-vehicle mounted display.

4. The messaging display system of claim 1, wherein the user selected criterion is a weighted combination of the daily average amount of time that an in-vehicle mounted display spends within the area of interest and the daily average distance traveled within the area of interest by an in-vehicle mounted display.

5. The messaging display system of claim 1, wherein each of the in-vehicle mounted displays are further comprised of a flexible border.

6. The messaging display system of claim 5, wherein the flexible borders are treated with a pressure sensitive adhesive, suitable to mount the in-vehicle mounted display to the rear window of a vehicle.

7. The messaging display system of claim 5, wherein the in-vehicle mounted displays are further comprised with a plurality of suction cups, suitable to mount the in-vehicle mounted display to the rear window of a vehicle.

8. The messaging display system of claim 5, wherein the flexible screen is an organic liquid crystal display.

9. A message display method comprising the steps of:
initiating a session by creating a message on an end-user electronic device and communicating the message to a server;
selecting an area of interest from a map using the end-user electronic device;
sending the area of interest to the server;
using the server to identify a plurality of in-vehicle mounted displays that frequent the area of interest;
communicating, from the server to the end-user electronic device, the in-vehicle mounted displays that are available to broadcast a message in the area of interest;
selecting, using the end-user electronic device, the in-vehicle mounted displays on which to broadcast the message;
setting, using the end-user electronic device, the duration of time for which the message will be broadcast;
setting, using the end-user electronic device, the number of repetitions to be made broadcasting the message;
communicating from the end-user electronic device to the server the desired in-vehicle mountable displays and vehicles on which to broadcast the message, the duration of each broadcast, and the number of repetitions of the broadcast to be made;
calculating a price for the broadcast using the server;
approving the price using the end-user electronic device; and
broadcasting the message on the in-vehicle mounted displays selected by the end-user electronic device in accordance with the duration and repetition requirements selected by the end-user electronic device.

10. The message display method of claim 9, further comprising the step of selecting display options for the message.

11. The message display method of claim 10, wherein the options are at least one of animation, text wrapping, color, and added graphics.
